(19) United States
(12) Patent Application Publication
(10) Pub. No.: US 2020/0403317 A1
(43) Pub. Date: Dec. 24, 2020

(54) TUNING FEATURES FOR LOW PROFILE HIGH DIELECTRIC CERAMIC ANTENNA

(71) Applicant: BAE Systems Information and Electronic Systems Integration Inc., Nashua, NH (US)

(72) Inventors: Young-Ki Kim, Bedford, NH (US); Arturs E. Dinbergs, Hollis, NH (US); Clint H. Perry, Londonderry, NH (US); Gregory J. Wunsch, Milford, NH (US)

(73) Assignee: BAE Systems Information and Electronic Systems Integration Inc., Nashua, NH (US)

(21) Appl. No.: 16/449,725

(22) Filed: Jun. 24, 2019

(51) Int. Cl. H01Q 9/04; G01S 19/01

(52) U.S. Cl. CPC H01Q 9/0442; G01S 19/01

(57) ABSTRACT

The present disclosure relates to tuning features for low profile high dielectric ceramic patch antenna. More particularly, the present disclosure relates to modifying a high dielectric ceramic patch antenna to compensate for variation within the dielectric constant. The disclosure relates to adding a tuning tab to a dielectric ceramic patch antenna with a high dielectric constant for operations at or near GPS tuning frequencies.

### TECHNICAL FIELD

The present disclosure relates generally to tuning features for a low profile high dielectric ceramic patch antenna. More particularly, the present disclosure relates to modifying a high dielectric ceramic patch antenna to compensate for variation within the dielectric constant. Specifically, in one embodiment, the present disclosure relates to adding a tuning feature to a patch antenna.

### BACKGROUND

Satellite radio navigation systems such as the Global Positioning System (GPS) are valuable tools for the navigation and tracking of moving platforms or projectiles. Such platforms may be ground or air vehicles, and may be manned or unmanned. Traditionally, GPS antennas for moving platforms or projectiles have been microstrip patch antennas which have a low vertical profile and low wind resistance. These antennas are traditionally lightweight, inexpensive, and typically only several inches square, and may protrude one or two centimeters above the surface of the platforms.

Traditional microstrip patch antennas usually comprise just one square or circular metal antenna element attached to a low-loss dielectric substrate. The substrate is then mounted on a larger ground plane, which serves as the return path for current induced on the patch element. The microstrip patch antenna performs optimally when it is sized such that the cavity beneath the patch resonates in its fundamental mode at the frequency of interest. This occurs when the resonant dimension of the patch is approximately one half-wavelength long within the dielectric substrate. While microstrip patch antennas inherently possess a narrow bandwidth, bandwidth enhancement techniques are possible to allow reception of wideband signals. Wide bandwidth antennas act to improve the accuracy of the navigation position solution.

Typical patch antennas have broad hemispherical radiation patterns, which enable them to acquire and track all GPS satellites above the horizon. However, this broad beam also receives radio energy from below the horizon. For ground or airborne platforms, this undesired energy typically originates from ground-based radio frequency interference (RFI) sources. In both cases, it is possible for the RFI to jam or interfere with the receiver and render it unusable or unreliable, thus preventing the user from navigating accurately with the satellite radio navigation system. Accuracy and frequency are paramount considerations when using various patch antennas.

### SUMMARY

As such, it may be advantageous to tune patch antennas, specifically those with high dielectric constants.

In one aspect, an exemplary embodiment of the present disclosure may provide a patch antenna comprising a substrate, a conductor forming a generally planar surface over top of the substrate and operatively coupled thereto, and a plurality of tabs cut into the conductor to expose the underneath substrate. This exemplary embodiment or another exemplary embodiment may further provide tuning abilities to compensate for varying dielectric constants, including when the substrate has a dielectric constant greater than 20. This exemplary embodiment or another exemplary embodiment may further provide for the substrate has a dielectric constant greater than 25. This exemplary embodiment or another exemplary embodiment may further provide for the conductor is rectangular shaped. This exemplary embodiment or another exemplary embodiment may further provide for the conductor to have an X-axis and a Y-axis that bisect the conductor and some of the plurality of tabs are located along the X-axis, and the remainder of the tabs are located along the Y-axis. This exemplary embodiment or another exemplary embodiment may further provide for the plurality of tabs to be four tabs. This exemplary embodiment or another exemplary embodiment may further provide for an area of a single tab of the plurality of tabs is 0.0032 square inches. This exemplary embodiment or another exemplary embodiment may further provide for the tabs to be twice as long side as they are wide. This exemplary embodiment or another exemplary embodiment may further provide for the plurality of tabs to be eight tabs. This exemplary embodiment or another exemplary embodiment may further provide for an area of a single tab of the plurality of tabs is 0.0008 square inches each. This exemplary embodiment or another exemplary embodiment may further provide for half of the plurality of tabs have an area of 0.0016 square inches and the other half have an area of 0.0008 square inches. This exemplary embodiment or another exemplary embodiment may further provide for the conductor to be approximately 722×688 mil in size. This exemplary embodiment or another exemplary embodiment may further provide for the substrate to be made of ceramic. This exemplary embodiment or another exemplary embodiment may further provide for the antenna has a resonance of about 1.56 GHz.

In a further aspect, an exemplary embodiment of the present disclosure may provide a patch antenna comprising: a substrate, a conductor carried by the substrate, including an outer perimeter edge, and a tuning feature of the antenna adjacent the outer perimeter edge. This exemplary embodiment or another exemplary embodiment may further provide for the tuning feature to be defined by at least one notch interrupting the outer perimeter edge. This exemplary embodiment or another exemplary embodiment may further provide for the outer perimeter edge to have four sides and there is one notch in each respective wide of the perimeter edge. This exemplary embodiment or another exemplary embodiment may further provide for the outer perimeter edge has two notches aligned along an X-axis of the conductor. This exemplary embodiment or another exemplary embodiment may further provide for the outer perimeter edge has two notches aligned along a Y-axis of the conductor. This exemplary embodiment or another exemplary embodiment may further provide for the substrate has a dielectric constant greater than 25. This exemplary embodiment or another exemplary embodiment may further provide for the conductor has an X-axis and a Y-axis that bisect the conductor and some of the tuning features are located along the X-axis, and the remainder of the tuning features are located along the Y-axis. This exemplary embodiment or another exemplary embodiment may further provide an area of a single tuning feature of the plurality of tuning features is 0.0032 square inches. This exemplary embodiment or another exemplary embodiment may further provide for the tuning features to be twice as long as they are wide. This exemplary embodiment or another exemplary embodiment may further provide that the plurality of tuning features is eight tuning features. This exemplary embodiment or another exemplary embodiment may further provide an area of a single tuning feature of the plurality of tuning features is 0.0008 square inches each. This exemplary embodiment or another exemplary embodiment may further provide half of the plurality of tuning features have an area of 0.0016 square inches and the other half of the tuning features have an area of 0.0008 square inches. This exemplary embodiment or another exemplary embodiment may further provide that the conductor is approximately 722×688 mil in size.

Another further aspect an exemplary embodiment of the present disclosure may provide a method of tuning an antenna to take into account dielectric constant variations comprising: obtaining a substrate, placing a conductor on top of the substrate, determining a dielectric constant that is desired to be tuned to, removing at least one portion of the conductor to the substrate underneath to tune to a dielectric constant of the substrate of the antenna. This exemplary embodiment or another exemplary embodiment may further provide removing four portions of identical size. This exemplary embodiment or another exemplary embodiment may further provide removing eight portions of identical size. This exemplary embodiment or another exemplary embodiment may further provide removing four portions of a first size and four portions of a second size. This exemplary embodiment or another exemplary embodiment may further provide that the substrate has a dielectric constant of about 25.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 (FIG. 1) is a top plan view of a traditional patch antenna.

FIG. 2 (FIG. 2) is a top plan view of a first embodiment of an exemplary patch antenna with a tuning structure.

FIG. 3 (FIG. 3) is a top plan view of a second embodiment of a further exemplary patch antenna with a further tuning structure.

FIG. 4 (FIG. 4) is a top plan view of a third embodiment of a further exemplary patch antenna with a further tuning feature.

FIG. 5 (FIG. 5) is a graph of performance of various patch antennas with various tuning features.

FIG. 6 (FIG. 6) is a graph of performance of further patch antennas with various tuning features.

FIG. 7 (FIG. 7) is a flow chart depicting an exemplary method relating to tuning a dielectric by creating various tuning features within a substrate.

Similar numbers refer to similar parts throughout the drawings.

### DETAILED DESCRIPTION

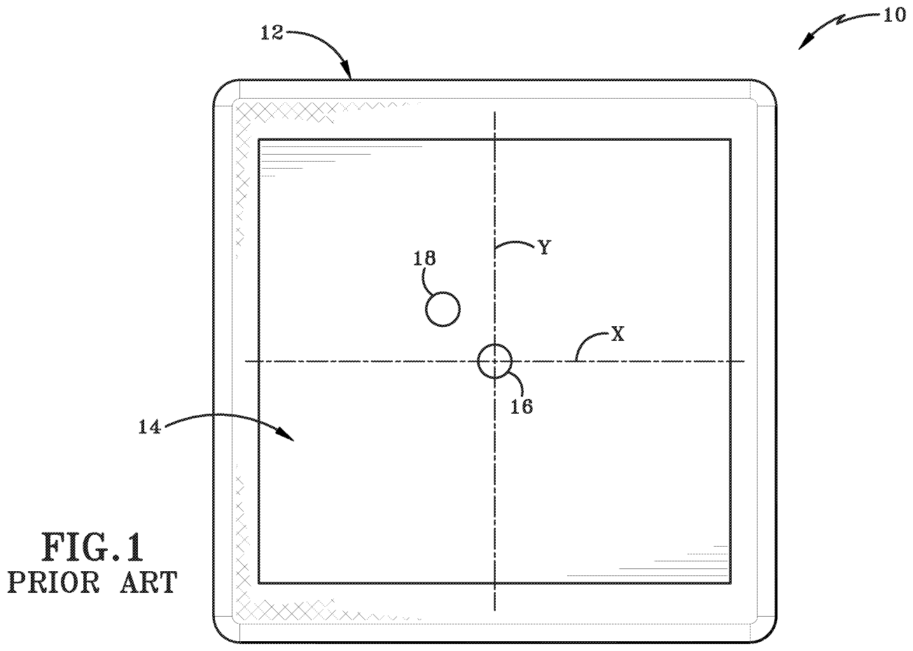

Exemplary devices and methods of operation are depicted in the present disclosure and throughout FIGS. 1-9. The exemplary methods discuss tuning a patch antenna to account for variation in dielectric constants. The patch antenna may then be attached to a movable platform.

In one particular embodiment, the moveable platform may be a precision guidance kit (PGK), operatively coupled with a munition body, which may also be referred to as a projectile, to create a guided projectile. The PGK may be connected to the munition body via a threaded connection; however, the PGK may be connected to the munition body in any suitable manner. The platform may be any vehicle or device that is operatively coupled from the PGK to the munition body forming the guided projectile. Alternatively, the movable platform can be any structure that would benefit from the advantages of having a tuned patch antenna.

Referring now to FIG. 1, a patch antenna is shown generally at 10. The traditional antenna 10 includes a substrate 12 and a conductor 14 coupled to the substrate 12. The conductor 14 forms a generally planar surface over top of the substrate 12. The conductor 14 may be connected to the substrate 12 by any known techniques. The conductor 14 is on the top surface of the patch antenna 10.

A reduction in size of conventional patch antennas can, however, only be achieved by appropriately selecting a particularly suitable substrate 12. Normally ceramic is used as the substrate 12, which should have as large an εᵣ value, or a relative permittivity value, as possible. For the purposes of this disclosure, εᵣ is approximately 25.0. Further εᵣ may be from about 20.0 to 26.0. At times εᵣ within this specification may be referred to as dielectric constant or DK. The conductor 14 includes a ground pin 16. Further, X and Y axes are defined along the middle of the conductor that bisects a ground pin aperture 16. Offset of the ground pin aperture 16 is a feed pin aperture 18.

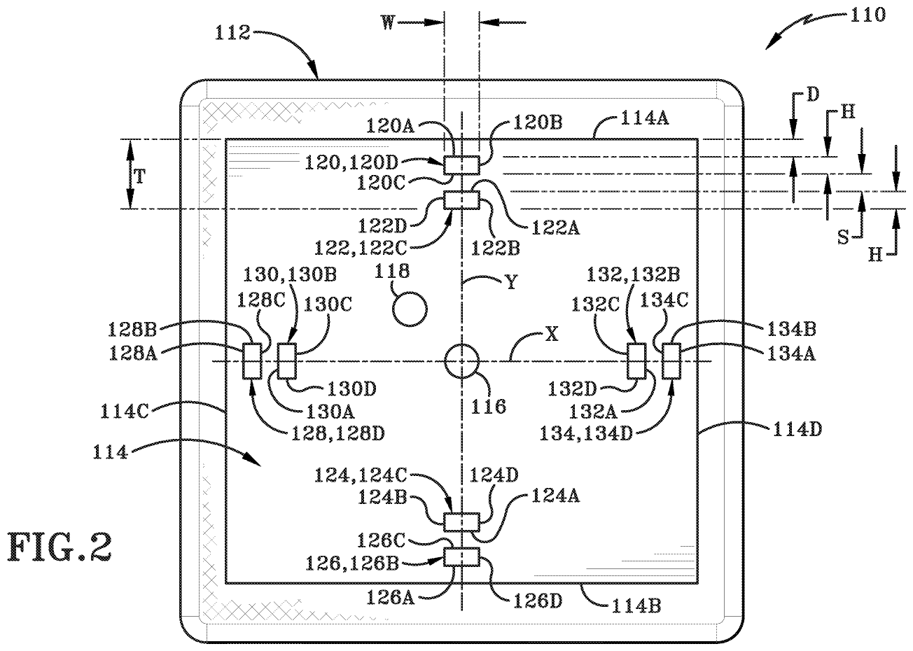

FIG. 2 is a top plan view of a first embodiment of a patch antenna 110 at the top surface with tuning apertures 120, 122, 124, 126, 128, 130, 132, 134. Similar to FIG. 1, the first embodiment of a patch antenna 110 includes a substrate 112 and a conductor 114 coupled to the substrate 112. In one embodiment the conductor 114 is on the top of substrate 112. The conductor 114 forms a generally planar surface over top of the substrate 112. The conductor 114 may be connected to the substrate 112 by any known techniques. The conductor 114 includes a ground pin 116. Further, X and Y axes are defined along the middle of the conductor that bisects the ground pin aperture 116. Offset of the ground pin aperture 116 is a feed pin aperture 118.

The patch antenna 110 in this embodiment further includes at least two pairs of uniform apertures 120, 122 and 124, 126 along the Y-axis and at least two pairs of uniform apertures 128, 130 and 132, 134. The apertures 120, 122 along the Y-axis have a width “W” and a height “H”. Additionally, the apertures include an inset distance “D”, defined by the distance from any edge 114A of the substrate 114 to a longitudinal edge defining aperture 120. Additionally, there is a spaced distance “S” defined by the distance between the apertures 120, 122. In this embodiment the distance of “D” and “S” are equal to each other, but need not be in all embodiments. The total distance of 2H+D+S together is represented by “T”.

First aperture 120 has a first side edge 120A that is spaced a distance “D” away from the edge of the conductor 114A and is parallel to the edge 114A of the conductor 114 and has a length and is defined by the distance “W”. A second side edge 120B of the first aperture 120 is perpendicular to the first side edge 120A and as such is at a right angle to the first side edge 120A. The second side edge 120B has a length and is defined by the distance “H”. A third side edge 120C of the first aperture 120 is perpendicular to the second side edge 120B and as such is at a right angle to the second side edge 120B while being parallel to the first side edge 120A. The third side edge 120C has a length and is defined by the distance “W”. A fourth side edge 120D of the aperture 120 is perpendicular to a third side edge 120C and as such is at a right angle to the third side edge 120C while being parallel to the second side edge 120B. The fourth side edge 120D has a length and is defined by the distance “H”. As such, the first aperture 120 forms a four sided rectangular area defined within the conductor 114. The first aperture 120 is centered along the Y-axis which bisects the entirety of the conductor 114 and as such also bisects the length of the first side edge 120A and third side edge 120C.

Second aperture 122 has a first side edge 122A that is spaced a distance “S” away from the third side edge 120C of the first aperture 120 and a distance of “D”+“H”+“S” away from the edge 114A of the conductor 114 and is parallel to the edge 114A of the conductor 114 and has a length and is defined by the distance “W”. A second side edge 122B of the second aperture 122 is perpendicular to the first side edge 122A and as such is at a right angle to the first side 122A. The second side edge 122B has a length and is defined by the distance “H”. A third side edge 122C of the second aperture 122 is perpendicular to the second side edge 122B and as such is at a right angle to the second side edge 122B while being parallel to the first side edge 122A. The third side edge 122C has a length and is defined by the distance “W”. A fourth side edge 122D of the second aperture 122 is perpendicular to a third side edge 122C and as such is at a right angle to the third side edge 122C while being parallel to the second side edge 122B. The fourth side edge 122D has a length and is defined by the distance “H”. As such, the second aperture 122 forms a four sided rectangular area defined within the conductor 114. The second aperture 122 is centered along the Y-axis which bisects the entirety of the conductor 114 and as such also bisects the length of the first side edge 122A and third side edge 122C.

For the purpose of brevity, the second pair 124, 126 have similar side edges, 124A, 124B, 124C, 124D and 126A, 126B, 126C, 126D centered with the Y-axis with identical distances away from a second edge 1146 of the conductor. Further, the at least two pairs of uniform apertures 128, 130 and 132, 134 have similar side edges 128A, 128B, 128C, 128D, 130A, 130B, 130C, 130D, 132A, 132B, 132C, 132E, 134A, 134B, 134C, 134 D and are centered along the X-axis about with identical distances away from a third edge 114C and fourth edge 114D, respectively.

It will be understood that the width of the further set of uniform apertures 128, 130, 132, 134 have the same measurements except in this orientation their “W” is their height and “H” is their width. The inset distances “D” and spaced distances “S” remain the same but instead are present along the X-axis rather than the Y-axis. Stated otherwise, they have the same dimensions that are rotated 90° and taken relative to the X-axis.

In this exemplary embodiment the size of the width “W” is about 0.02-0.06 inches. In one embodiment it is 0.04 inches. The size of the inset distance “D” is about 0.01-0.03 inches. In one embodiment it is 0.02 inches. The size of the height “H” is about 0.01-0.03 inches. In one embodiment it is 0.02 inches. The size of the spaced distance “S” is about 0.01-0.03 inches. In one embodiment it is 0.02 inches. As such, the size of the total distance “T” is about 0.04-0.12 inches. In one embodiment it is 0.08 inches. It will be understood this is merely an exemplary embodiment and other dimensions could be used. When dimensions are varied tuning may change in a response to the variation in dimensions.

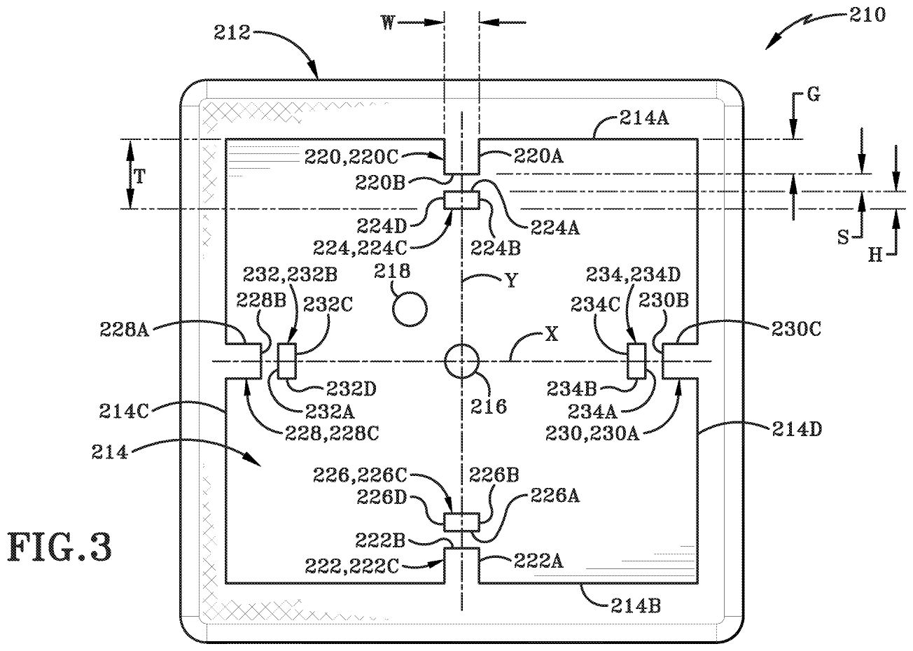

FIG. 3 depicts a top plan view of a second embodiment of a patch antenna 210 with a tuning structures 220, 222, 224, 226, 228, 230, 232, 234. Similar to the previous discussions, the second embodiment 210 includes a substrate 212 and a conductor 214 coupled to the substrate 212. The conductor 214 forms a generally planar surface over top of the substrate 212. The conductor 214 may be connected to the substrate 212 by any known techniques. The conductor 214 is on the top surface of the patch antenna 210. The conductor 214 includes a ground pin 216. Further, X and Y axes are defined along the middle of the conductor that bisects the ground pin aperture 216. Offset of the ground pin aperture 216 is a feed pin aperture 218.

The patch antenna 210 further includes two notches 220, 222 on the Y-axis along with two apertures 224, 226 on the Y-axis and two further notches 228, 230 on the X-axis along with two further apertures 232, 234 on the X-axis. The notches 220, 222 and apertures 224, 226 along the Y-axis have a common width “W”. However, in contrast to the first embodiment 110, the notches 220, 222 and apertures 224, 226 have different heights. The notches 220, 222 have a height of “G”, while the apertures 224, 226 have a height of “H”. Eliminated is the inset distance “D”, but remaining is a spaced distance “S” defined by the longitudinal distance between a single notch 220 and single aperture 224. The total distance “T” is represented by G+H+S.

First notch 220 has a first side edge 220A perpendicular and at a right angle to a first edge 214A of the conductor 214. The first side edge 220A has a length and is defined by the distance “G”. A second side edge 220B of the first notch 220 is perpendicular to the first side edge 220A and as such is at a right angle to the first side edge 220A. The second side edge 220B has a length and is defined by the distance “W”. A third side edge 220C of the first notch 220 is perpendicular to the second side edge 220B and as such is at a right angle to the second side edge 220B while being parallel to the first side edge 220A. The third side edge 220C has a length and is defined by the distance “G”. As such, the first notch 220 forms a three sided open rectangular area defined within the conductor 214. The first notch 220 is centered along the Y-axis which bisects the entirety of the conductor 214 and as such also bisects the length of the second side edge 220B.

First aperture 224 has a first side edge 224A that is spaced a distance “S” away from the second side edge 220B of the first notch 220 and a distance of “G”+“H” away from the edge 214A of the conductor 214 and is parallel to the edge 214A of the conductor 214 and has a length and is defined by the distance “W”. A second side edge 224B of the first aperture 224 is perpendicular to the first side edge 224A and as such is at a right angle to the first side 224A. The second side edge 224B has a length and is defined by the distance “H”. A third side edge 224C of the first aperture 224 is perpendicular to the second side edge 224B and as such is at a right angle to the second side edge 224B while being parallel to the first side edge 224A. The third side edge 224C has a length and is defined by the distance “W”. A fourth side edge 224D of the first aperture 224 is perpendicular to a third side edge 224C and as such is at a right angle to the third side edge 224C while being parallel to the second side edge 224B. The fourth side edge 224D has a length and is defined by the distance “H”. As such, the first aperture 122 forms a four sided rectangular area defined within the conductor 114. The first aperture 224 is centered along the Y-axis which bisects the entirety of the conductor 224 and as such also bisects the length of the first side edge 224A and third side edge 224C.

For the purpose of brevity, the remaining notch 222, has similar side edges, 222A, 222B, 222C, centered with the Y-axis with identical distances away from a second edge 214B of the conductor, along with its corresponding second aperture 226 with side edges 226A, 226B, 226C, 226D. Further, the further notches 228, 230 have similar side edges 228A, 228B, 228C, 230A, 230B, 230C along with their associated apertures 232, 234 with their side edges 232A, 232B, 232C, 232D, 234A, 234B, 234C, 234D are centered along the X-axis about with identical distances away from a third edge 214C and fourth edge 214D, respectively.

It will be understood that the width of the and two further notches 228, 230 on the X-axis along with two further apertures 232, 234 have the same measurements to their Y-axis counter parts except within a different frame of reference. Stated otherwise, they have the same dimensions that are rotated 90° and taken relative to the X-axis.

In this exemplary second embodiment the size of the width “W” is about 0.02-0.06 inches. In one embodiment it is 0.04 inches. The size of the notch height “G” is about 0.02-0.06 inches. In one embodiment it is 0.04 inches. The size of the height “H” is 0.02 inches. The size of the spaced distance “S” is about 0.01-0.03 inches. In one embodiment it is 0.02 inches. As such, the size of the total distance “T” is about 0.04-0.12 inches. In one embodiment it is 0.08 inches. It will be understood this is merely an exemplary embodiment and other dimensions could be used. It will be understood this is merely an exemplary embodiment and other dimensions could be used.

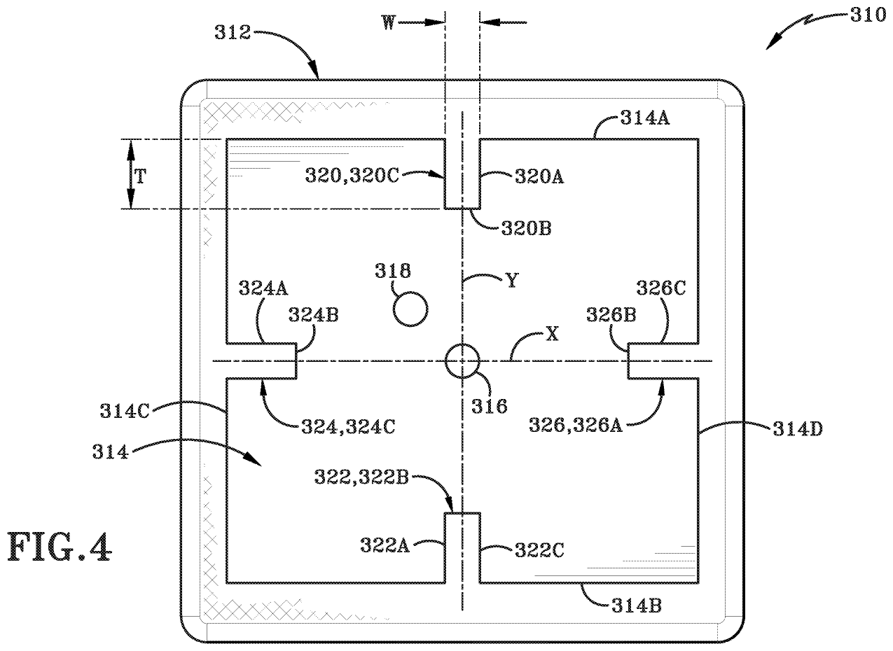

FIG. 4 depicts a top plan view a third embodiment of a patch antenna 310 at the top surface with a tuning structure 320, 322, 324, 326. Similar to the previous embodiments, the third embodiment 310 includes a substrate 312 and a conductor 314 on top of the substrate 312. The conductor 314 forms a generally planar surface over top of the substrate 312. The conductor 314 may be connected to the substrate 312 by any known techniques. The conductor 314 is on the top surface of the patch antenna 310. The conductor 314 includes a ground pin 316. Further, X and Y axes are defined along the middle of the conductor that bisects the ground pin aperture 316. Offset of the ground pin aperture 16 is a feed pin aperture 18.

The patch antenna 310 further includes two notches 320, 322 on the Y-axis along with two notches 324, 326 on the X-axis. The notches 320, 322 along the Y-axis have a common width “W”. However, in contrast to the first embodiment 110 and second embodiment, there is only one height, the total distance “T”. Eliminated is the inset distance “D”, and a spaced distance “S” defined by the longitudinal distance between any notch and any aperture.

First notch 320 has a first side edge 320A perpendicular and at a right angle to a first edge 314A of the conductor 314. The first side edge 320A has a length and is defined by the distance “T”. A second side edge 320B of the first notch 320 is perpendicular to the first side edge 320A and as such is at a right angle to the first side edge 320A. The second side edge 320B has a length and is defined by the distance “W”. A third side edge 320C of the first notch 320 is perpendicular to the second side edge 320B and as such is at a right angle to the second side edge 320B while being parallel to the first side edge 320A. The third side edge 320C has a length and is defined by the distance “T”. As such, the first notch 320 forms a three sided open rectangular area defined within the conductor 314. The first notch 320 is centered along the Y-axis which bisects the entirety of the conductor 314 and as such also bisects the length of the second side edge 320B.

For the purpose of brevity, the remaining notch 322 along the Y-axis, has similar side edges, 322A, 322B, 322C, centered with the Y-axis with identical distances away from a second edge 314B of the conductor. Further, the further notches 324, 326 have similar side edges 324A, 324B, 324C, 326A, 326B, 326C are centered along the X-axis about with identical distances away from a third edge 314C and fourth edge 314D, respectively.

It will be understood that the width of the and two further notches 324, 326 on the X-axis have the same measurements to their Y-axis counter parts except within a different frame of reference. Stated otherwise, they have the same dimensions that are rotated 90° and taken relative to the X-axis. In this exemplary third embodiment the size of the width “W” is about 0.02-0.06 inches. In one embodiment it is 0.04. The total distance “T” is about 0.04-0.12 inches. In one embodiment it is 0.08 inches. It will be understood this is merely an exemplary embodiment and other dimensions could be used.

Exemplary conductors 14, 114, 214, 314 may be generally rectangular in shape. Exemplary conductors may have the following dimensions: 724×688, 728×692, 734×698, all of these are measured in mil ( 1/1000 inch). As used herein the dimensions define an outer perimeter edge as a continuous edge and does not include the regions which are cut out from the antenna. For example, there may be an upper edge, lower edge, first side edge that goes from the upper edge to the lower edge and a second side edge that goes from the lower edge to the upper edge. As such, an outer perimeter will be understood to be a four sided dimension prior to the addition of any tuning features.

Having thus described an exemplary non-limiting configuration of the various embodiments 110, 210, 310, its operation will be discussed with reference to some exemplary features used with the various embodiments 110, 210, 310.

A batch of patch antennas includes approximately 7000 antennas and one of the highly variable tolerance factors is the DK variation in terms of batch to batch variation. An overall mean of the dielectric constant in an exemplary batch is 24.82 and the tolerance is ±0.5 with a σ=0.23. Additionally, antenna elements do not have the broad bandwidth needed to cover this inherent DK variation due to the high dielectric constant paired with low profile antenna features of patch style antennas.

Therefore, tuning features (i.e. notches/apertures) were added in order to compensate the DK variation and are shown in FIGS. 2-4. Various apertures and notches (or tabs) were therefore added to the patch antenna for each side from the center of the patch. These tuning tabs can be trimmed by a LPKF machine as needed.

The antenna performance did not change when compared to an antenna with no tuning feature or tab (as shown in FIG. 1). The tuning technique also allows a less constant DK to be used without loss in antenna performance, as will be discussed with respect to the tables below.

### Example 1—Small Patch Design 1—724×688 Patch Size

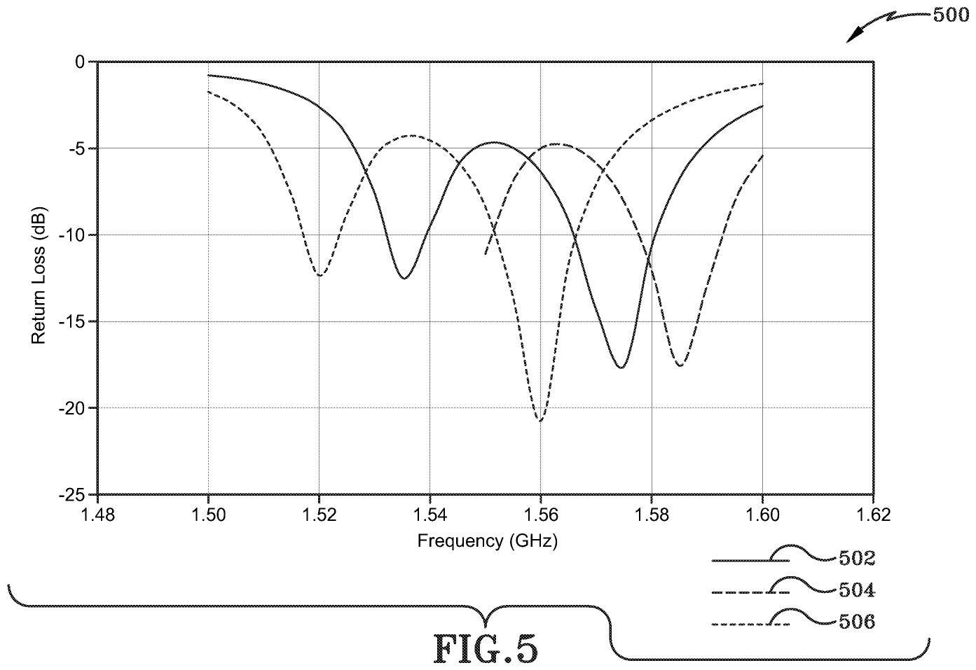

FIG. 5 is a graph 500 of various patch designs and their return loss as a function of frequency. The solid line 502 refers to the patch design of FIG. 2, or the first embodiment. This patch design was optimized at a DK of 25.4 for purposes of the simulation. This is due to the fact that the mean DK is 24.82 for a batch of antennas, and the variation may be plus or minus 0.4, as such the highest DK should be 25.32, therefore 25.4 was chosen for the simulation. The large dashed line 504 refers to the to the patch design of FIG. 2, or the first embodiment with a DK of 25.0. The small dashed line 506 refers to the patch design of FIG. 4, or the third embodiment with activating the max range of the tuner with a DK of 25.0.

The solid line 502 with the patch design of FIG. 2 shows an optimized antenna return loss with the highest (or worst) DK variation of 25.4 at a resonance frequency of 1575 MHz (or 1.575 GHz). Note that 1575 MHz is the GPS's working frequency. The large dashed line 504 refers to a similar patch design of FIG. 2 with a lower DK of 25. Note that it no longer operates at the desired working frequency and has been shifted up in frequency to 1.585 GHz due to the lower DK of the ceramic. As such, the FIG. 2 patch with a DK of 25 shows a return loss response variation due to the DK variations of the ceramic. The small dashed line 506 refers to the patch design of FIG. 4, of which the return loss has been tuned (shifted down) to 1.56 GHz. which the tuning feature is able to tune the antenna accounting for DK variations for high DK ceramics at the working frequency of GPS antennas.

The following Tables 1-8 show that there is little to no performance degradation of the underlying antenna at various frequencies of Example 1 when the tuning feature is added. The patch antenna 114 of FIG. 2 is compared to the patch antenna 14 of FIG. 1. Tables 1-4 refer to a tuned patch with the configuration of FIG. 2 with a DK of 25.4 at a frequency greater than 1575 MHz, and a patch size of 724×688 mil at various frequencies, namely: 1570 MHz for Table 1, 1575 MHz for Table 2, 1560 MHz for Table 3 and 1590 MHz for Table 4. While Tables 5-8 refer to a patch antenna of FIG. 1 with a DK of 25.4, frequency of 1575 MHz, and a patch size of 724×688 mil at various frequencies, namely: 1570 MHz for Table 5, 1575 MHz for Table 6, 1560 MHz for Table 7 and 1590 MHz for Table 8. The numbers relate to the pattern of the antenna.

TABLE 1
1570 MHz
dB(RealizedGa1nRHCP)

| | |
|---|---|
| HIGH | 3.7659 |
| | 0.3825 |
| | −3.0009 |
| | −6.3842 |
| | −9.7676 |
| | −13.1510 |
| | −16.5344 |
| | −19.9178 |
| | −23.8011 |
| | −26.6645 |
| | −30.0679 |
| | −33.4513 |
| | −36.8347 |
| | −40.2180 |
| LOW | −43.6014 |
| | −46.9848 |

TABLE 2
1575 MHz
dB(RealizedGainRHCP)

| | |
|---|---|
| HIGH | 3.6250 |
| | −0.4060 |
| | −4.4370 |
| | −8.4680 |
| | −12.4990 |
| | −16.5300 |
| | −20.5610 |
| | −24.5920 |
| | −28.6230 |
| | −32.6540 |
| | −36.6850 |
| | −40.7160 |
| | −44.7469 |
| | −48.7779 |
| LOW | −52.8089 |
| | −56.8399 |

TABLE 3
1560 MHz
dB(RealizedGainRHCP)

| | |
|---|---|
| HIGH | 2.6081 |
| | −0.3815 |
| | −3.3712 |
| | −6.3608 |
| | −9.3504 |
| | −12.3401 |
| | −15.3297 |
| | −18.3193 |
| | −21.3090 |
| | −24.2986 |
| | −27.2882 |
| | −30.2779 |
| | −33.2675 |
| | −36.2571 |
| LOW | −39.2468 |
| | −42.2364 |

TABLE 4
1590 MHz
dB(RealizedGainRHCP)

| | |
|---|---|
| HIGH | 1.6756 |
| | −1.8872 |
| | −5.4501 |
| | −9.0129 |
| | −12.5758 |
| | −16.1387 |
| | −19.7015 |
| | −23.2644 |
| | −26.8272 |
| | −30.3901 |
| | −33.9529 |
| | −37.5158 |
| | −41.0787 |
| | −44.6415 |
| LOW | −48.2044 |
| | −51.7672 |

TABLE 5
1570 MHz
dB(RealizedGainRHCP)

| | |
|---|---|
| HIGH | 3.7893 |
| | −0.0272 |
| | −3.8437 |
| | −7.6602 |
| | −11.4767 |
| | −15.2932 |
| | −19.1097 |
| | −22.9262 |
| | −26.7427 |
| | −30.5592 |
| | −34.3757 |
| | −38.1922 |
| | −42.0087 |
| | −45.8252 |
| LOW | −49.6417 |
| | −53.4582 |

TABLE 6
1575 MHz
dB(RealizedGainRHCP)

| | |
|---|---|
| HIGH | 3.6867 |
| | 0.2553 |
| | −3.1762 |
| | −6.6077 |
| | −10.0391 |
| | −13.4706 |
| | −16.9020 |
| | −20.3335 |
| | −23.7650 |
| | −27.1964 |
| | −30.6279 |
| | −34.0594 |
| | −37.4908 |
| | −40.9223 |
| LOW | −44.3537 |
| | −47.7852 |

TABLE 7
1560 MHz
dB(RealizedGainRHCP)

| | |
|---|---|
| HIGH | 2.5335 |
| | −0.4136 |
| | −3.3607 |
| | −6.3078 |
| | −9.2549 |
| | −12.2020 |
| | −15.1492 |
| | −18.0963 |
| | −21.0434 |
| | −23.9905 |
| | −26.9376 |
| | −29.8847 |
| | −32.8318 |
| | −35.7789 |
| LOW | −38.7260 |
| | −41.6731 |

TABLE 8
1590 MHz
dB(RealizedGainRHCP)

| | |
|---|---|
| HIGH | 1.7900 |
| | −1.7082 |
| | −5.2063 |
| | −8.7045 |
| | −12.2026 |
| | −15.7007 |
| | −19.1989 |
| | −22.6970 |
| | −26.1951 |
| | −29.6933 |
| | −33.1914 |
| | −36.6895 |
| | −40.1877 |
| | −43.6858 |
| LOW | −47.1840 |
| | −50.6821 |

### Example 2—Small Patch Design 2—722×686 Patch Size

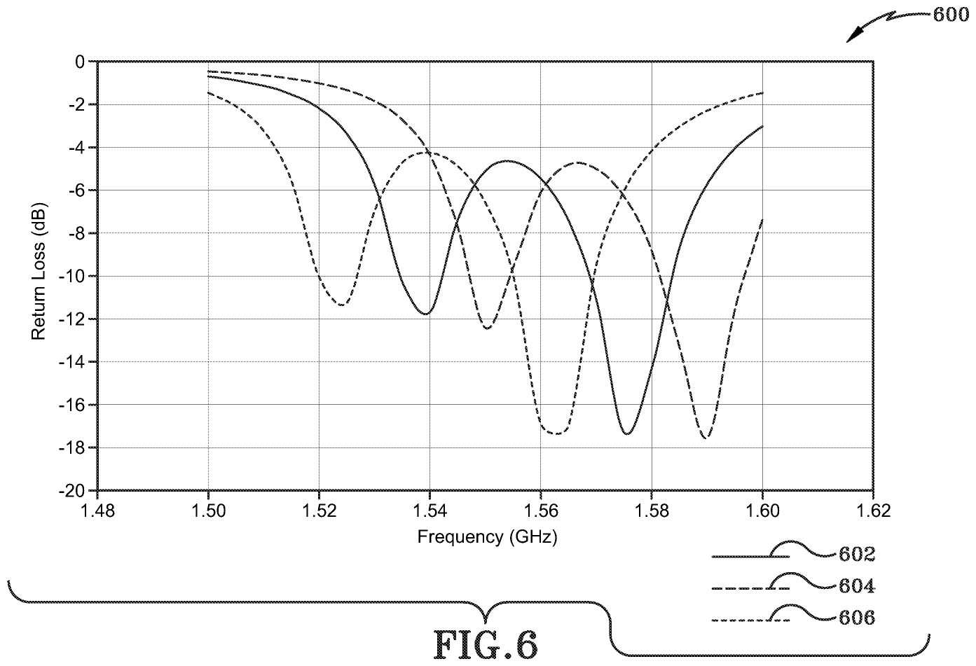

FIG. 6 shows a graph 600 of various patch designs and their return loss as a function of frequency. The solid line 602 refers to the patch design of FIG. 2, or the first embodiment. This patch design was optimized at a DK of 25.4. The large dashed line 604 refers to the to the patch design of FIG. 2, or the first embodiment with a DK of 25.0. The small dashed line 606 refers to the patch design of FIG. 4, or the third embodiment with activating the max range of the tuner with a DK of 25.0.

The solid line 602 with the patch design of FIG. 2 shows an optimized antenna return loss with the highest (or worst) DK variation (25.4) at a resonance frequency of 1575 MHz (or 1.575 GHz). The large dashed line 604 refers to a similar patch design of FIG. 2 with a DK reduced to 25. Note that it works outside of the desired operating frequency (1.575 GHz) and has been shifted up to 1.59 GHz due to the lower DK of the ceramic. As such, the FIG. 2 patch with a DK of 25 shows a return loss response variation due to the DK variations of the ceramic in a smaller patch size than was shown in Example 1. When showing the small dashed line 606 referring to the patch design of FIG. 4, the return loss can be tuned (shifted down) to 1.565 GHz. The tuning feature is able to tune the antenna accounting for DK variations for high DK ceramics at the working frequency of GPS antennas.

The following Tables 9-16 show that there is little to no performance degradation of the underlying antenna at various frequencies of small patch design 1 when the tuning feature is added. The patch antenna of FIG. 2 is compared to the patch antenna of FIG. 1. Tables 9-12 refer to a tuned patch with the configuration of FIG. 2 with a DK of 25.4, and a patch size of 722×686 mil at various frequencies, namely: 1570 MHz for Table 9, 1575 MHz for Table 10, 1560 MHz for Table 11 and 1590 MHz for Table 12. While Tables 13-16 refer to a patch antenna of FIG. 1 with a DK of 25.4, and a patch size of 722×686 mil at various frequencies, namely: 1570 MHz for Table 13, 1575 MHz for Table 14, 1560 MHz for Table 15 and 1590 MHz for Table 16.

TABLE 9
1570 MHz
dB(RealizedGainRHCP)

| | |
|---|---|
| HIGH | 3.6076 |
| | −0.1171 |
| | −3.8419 |
| | −7.5666 |
| | −11.2914 |
| | −15.0161 |
| | −18.7408 |
| | −22.4656 |
| | −26.1903 |
| | −29.9151 |
| | −33.6398 |
| | −37.3646 |
| | −41.0893 |
| | −44.8141 |
| LOW | −48.5388 |
| | −52.2636 |

TABLE 10
1575 MHz
dB(RealizedGainRHCP)

| | |
|---|---|
| HIGH | 3.7566 |
| | −0.6760 |
| | −5.1085 |
| | −9.5411 |
| | −13.9737 |
| | −18.4062 |
| | −22.8388 |
| | −27.2714 |
| | −31.7039 |
| | −36.1365 |
| | −40.5691 |
| | −45.0016 |
| | −49.4342 |
| | −53.8668 |
| LOW | −58.2993 |
| | −62.7319 |

TABLE 11
1590 MHz
dB(RealizedGainRHCP)

| | |
|---|---|
| HIGH | 1.8425 |
| | −2.4618 |
| | −6.7660 |
| | −11.0702 |
| | −15.3745 |
| | −19.6767 |
| | −23.9829 |
| | −28.2872 |
| | −32.5914 |
| | −36.8957 |
| | −41.1999 |
| | −45.5041 |
| | −49.8084 |
| | −54.1126 |
| LOW | −58.4168 |
| | −62.7211 |

TABLE 12
1560 MHz
dB(RealizedGainRHCP)

| | |
|---|---|
| HIGH | 2.2193 |
| | −2.1663 |
| | −6.5520 |
| | −10.9376 |
| | −15.3232 |
| | −19.7088 |
| | −24.0944 |
| | −28.4800 |
| | −32.8656 |
| | −37.2513 |
| | −41.6369 |
| | −46.0225 |
| | −50.4081 |
| | −54.7937 |
| LOW | −59.1793 |
| | −63.5649 |

TABLE 13
1570 MHz
dB(RealizedGainRHCP)

| | |
|---|---|
| HIGH | 3.5909 |
| | 0.0737 |
| | −3.4434 |
| | −6.9606 |
| | −10.4777 |
| | −13.9949 |
| | −17.5120 |
| | −21.0292 |
| | −24.5463 |
| | −28.0635 |
| | −31.5806 |
| | −35.0978 |
| | −38.6149 |
| | −42.1321 |
| LOW | −45.6492 |
| | −49.1664 |

TABLE 14
1575 MHz
dB(RealizedGainRHCP)

| | |
|---|---|
| HIGH | 3.7636 |
| | 0.1303 |
| | −3.5031 |
| | −7.1364 |
| | −10.7698 |
| | −14.4031 |
| | −18.0364 |
| | −21.6698 |
| | −25.3031 |
| | −28.9365 |
| | −32.5698 |
| | −36.2031 |
| | −39.8365 |
| | −43.4698 |
| LOW | −47.1031 |
| | −50.7365 |

TABLE 15
1590 MHz
dB(RealizedGainRHCP)

| | |
|---|---|
| HIGH | 1.7947 |
| | −1.0576 |
| | −3.9099 |
| | −6.7622 |
| | −9.6145 |
| | −12.4668 |
| | −15.3191 |
| | −18.1714 |
| | −21.0237 |
| | −23.8760 |
| | −26.7284 |
| | −29.5807 |
| | −32.4330 |
| | −35.2853 |
| LOW | −38.1376 |
| | −40.9899 |

TABLE 16
1560 MHz
dB(RealizedGainRHCP)

| | |
|---|---|
| HIGH | 2.3107 |
| | −1.3041 |
| | −4.9188 |
| | −8.5336 |
| | −12.1483 |
| | −15.7631 |
| | −19.3779 |
| | −22.9926 |
| | −26.6074 |
| | −30.2222 |
| | −33.8369 |
| | −37.4517 |
| | −41.0664 |
| | −44.6812 |
| LOW | −48.2960 |
| | −51.9107 |

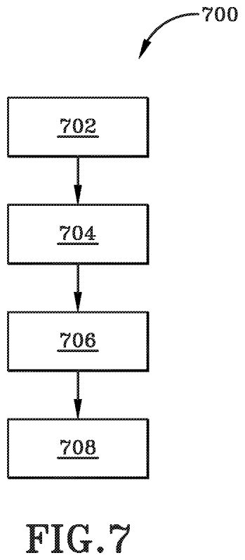

FIG. 7 depicts a flow chart in accordance with an exemplary method of the present disclosure generally at 700. The flowchart of method 700 is a method of tuning a resonance frequency for an antenna comprising: obtaining a substrate 702, placing a conductor on top of the substrate 704, determining a patch antenna that is desired to be tuned to a resonance frequency 706, and removing a portion of the conductor from the substrate underneath to tune the resonance frequency of the patch antenna 708. Various sizes including those previously discussed with respect to the embodiments 110, 210, 310 have been contemplated.

It should be noted that the number of apertures may vary depending upon the application as these may be optimized based on a specific application, ground structure and varying radiation environments. There is no need for the apertures to be paired, this is but one exemplary embodiment. There may be as few as one and as many as needed to accomplish the given application. Many of the tuning features can be optimized based on desired specific applications, ground structure and radiation environments. Additional shapes have been contemplated and may be used depending on these various criteria.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though they are shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A patch antenna comprising:
a substrate;
a conductor carried by the substrate including an outer perimeter edge; and
at least one tuning feature on the conductor interior the outer perimeter edge.

2. The patch antenna of claim 1, wherein the at least one tuning feature is defined by at least one notch interrupting the outer perimeter edge.

3. The patch antenna of claim 2, wherein the outer perimeter edge has four sides and there is at least one notch in each respective side of the perimeter edge.

4. The patch antenna of claim 3, wherein the outer perimeter edge has two notches aligned along an X-axis of the conductor.

5. The patch antenna of claim 4, wherein the outer perimeter edge has two notches aligned along a Y-axis of the conductor.

6. The patch antenna of claim 1, wherein the substrate has a dielectric constant greater than 25.

7. The patch antenna of claim 1, wherein the conductor has an X-axis and a Y-axis that bisect the conductor and some of the tuning features are located along the X-axis, and the remainder of the tuning features are located along the Y-axis.

8. The patch antenna of claim 1, wherein an area of a single tuning feature of the at least one tuning features is approximately 0.0032 square inches.

9. The patch antenna of claim 7, wherein the at least one tuning features are twice as long as they are wide.

10. The patch antenna of claim 1, wherein the at least one tuning features is eight tuning features.

11. The patch antenna of claim 10, wherein an area of a single tuning feature of the at least one tuning feature is 0.0008 square inches each.

12. The patch antenna of claim 10, wherein there are an even number of tuning features and half of the tuning features have an area of 0.0016 square inches and the other half of the tuning features have an area of 0.0008 square inches.

13. The patch antenna of claim 1, wherein the conductor is approximately 722×688 mil in size.

14. The patch antenna of claim 1, wherein the at least one tuning feature is one or more apertures proximate the outer perimeter edge with a section of the conductor between the apertures.

15. The patch antenna of claim 1, wherein at least one section of the conductor is removed for tuning the antenna.

16. The patch antenna of claim 1, wherein the antenna has a resonance of about 1.56 GHz.

17. A method of tuning a resonance frequency for an antenna comprising:
obtaining a substrate;
placing a conductor on top of the substrate;
determining a patch antenna that is desired to be tuned to a resonance frequency; and
removing a portion of the conductor to the substrate underneath to tune the resonance frequency of the patch antenna.

18. The method of claim 17, wherein removing further includes removing four portions of identical size.

19. The method of claim 17, wherein removing further includes removing eight portions of identical size.

20. The method of claim 17, wherein removing further includes removing four portions of a first size and four portions of a second size.
